(19) United States
(12) Patent Application Publication
(10) Pub. No.: US 2012/0003376 A1
(43) Pub. Date: Jan. 5, 2012

(54) INSTANT OIL FRIED NOODLE CONTAINING IRON AND ITS PROCESS OF PREPARATION

(75) Inventor: Mohammad Shameem Alam, Badda, Dhaka (BD)

(73) Assignee: NESTEC S.A., Vevey (CH)

(21) Appl. No.: 12/972,989

(22) Filed: Dec. 20, 2010

(30) Foreign Application Priority Data
Dec. 23, 2009 (SG) PCT/SG09/000490

(51) Int. Cl. A23L 1/162; A23L 1/304

(52) U.S. Cl. 426/557; 426/439; 426/451

(57) ABSTRACT

An instant oil fried noodle comprising an amount of iron between 26 and 35 mg for 100 g of noodles, between 1 and 20% of oil, between 60 and 90% of flour, up to 2% of kansui ingredient and a water content between 2 and 12% is provided.

### BACKGROUND

The present invention concerns an instant oil fried noodle containing iron and a process for its preparation.

It is already known to have an instant oil fried noodle containing iron. The problem with this existing product is first that the content of iron in the finished product is not enough high and secondly there is a problem of stability throughout the shelf life of nine months.

### SUMMARY

The present invention provides a finished product with a higher iron content, with a good stability during the shelf life. The problem of the stability is because of the development of an off-taste during the storage: this is due to the fact that iron acts as a catalyst for the oil oxidation and results color change and generate rancid flavor. Furthermore, the product according to the invention allows to obtain a good homogeneity of the iron in the product: this is a very important feature, and gives therefore the possibility to decrease the iron content, whereas reaching a sufficient daily presence of iron in 100 g of noodles, which is normally of 18 mg per day. A final aspect of the invention is to have a fortified noodle without using a fortified flour: the objective of the invention is to proceed with a normal flour.

The present invention provides an instant oil fried noodle comprising an amount of iron between 26 and 35 mg for 100 g of noodles, between 1 and 20% of oil, between 60 and 90% of flour, up to 2% of kansui ingredient and a water content between 2 and 12%. All the percentages are given in weight.

The product existing on the market has only 10 mg of iron based on 100 g of finished product. With the product of the invention, it is possible with 100 g of noodle to cover the necessary amount of iron for a day for a person.

The kansui ingredient is a mixture of alkaline salts, like sodium and potassium salt additives, like chloride, carbonate and/or phosphate.

The iron compound used according to the invention is taken in the group consisting of ferric pyrophosphate, sodium ferric EDTA, elemental iron and ferrous ammonium phosphate. The ferric pyrophosphate used can be micronized or regular. Concerning the elemental iron, it can be reduced or electrolytic. Although all 4 types of iron compounds can be used the preferred is ferric pyrophosphate.

The type of flour used is not critical. The flour is taken in the group consisting of rice, barley, maize, millet and multigrain flour. Other flours from other cereals known by the man skilled in the art are also possible.

The oil used according to the invention is not critical. The oil used is preferably palm oil. But other oils, like palm olein, corn oil, sunflower oil and other vegetable oils are also possible. In the case of palm oil, the use of refined or super refined palm oil can be an advantage.

The instant oil fried noodle of the invention contains further up to 30% of native or modified starch from corn, tapioca or potato. Preferably, the amount of starch is comprised between 20 and 25%.

The invention concerns further the process to prepare the instant noodle of the invention.

Additional features and advantages are described herein, and will be apparent from the following Detailed Description.

### DETAILED DESCRIPTION

An instant oil fried noodle comprising an amount of iron between 26 and 35 mg for 100 g of noodles, between 1 and 20% of oil, between 60 and 90% of flour, up to 2% of kansui ingredient and a water content between 2 and 12% is provided.

According to a first embodiment of the invention, the process for the preparation of the instant oil-fried noodle, comprises

a first step of preparation of an iron premix with flour, iron compound and

a second step of introduction of the iron premix in a mixer with the required amount of flour and oil, mixing at high speed, adding kansui ingredient and mixing again at high speed and wherein the obtained dough is processed by kneading, rolling into sheets, slitting, steaming and drying or frying.

The kansui ingredient is the same as disclosed above.

In the case of drying, this drying is carried out by air. In the case of frying, the frying is carried out in oil. The oil used is not critical and can be taken in the group consisting of palm oil, palm olein, corn oil, sunflower oil and other vegetable oils.

According to a second embodiment of the invention, the instant oil fried noodles are prepared according the knowledge of our patent application WO 2006/066609.

According to this second embodiment, the process for the preparation of the instant oil-fried noodle, comprises

preparing a mixture of oil, wheat flour, iron compound, water

adding to this mixture a concentrate comprising sodium and potassium salt additives, like chloride, carbonate and/or phosphate,

processing said dough mixture by kneading rolling into sheets, cutting into strips and steaming and

drying the dough mixture with air.

The consumer has then ready to use instant oil fried noodle. As instant, we understand a noodle product which can be cooked in 2-3 minutes in boiling water.

It can be also considered according to the invention to minimize the content of oil to near zero %. Also possible is to consider having noodles which are long cooking.

The following examples further illustrate the present invention.

### Comparative Examples

A trial has been carried out with a recipe containing 75% of wheat flour, 2% kansui, 23% water and the same amount of iron.

In the base of this recipe 3 different samples have been prepared.

Sample A: with a fortified wheat flour

Sample B: according to the invention

Sample C: with iron, with normal wheat flour

The results are given in the following table:

| | Standard deviation | Coefficient of |
|---|---|---|
| Sample | (mg) | variance (%) |
| A | 1.41 | 5.64 |
| B | 0.71 | 2.76 |
| C | 1.66 | 6.64 |

These results show clearly that according to the invention, the standard deviation and the coefficient of variance are minimized. That means, that according to the invention, you do not need to overdose the amount of iron, because of the good homogeneity of repartition of iron in the mass.

You do therefore an economy of iron.

### EXAMPLE 1

In a first step, we prepare an iron premix on the following manner:

Prepare 25 kg of a premix containing 23-24 kg of wheat flour with 1-2 kg of ferric pyrophosphate,

Load a blender and mix for 20-30 minutes

In a second step:

Load the dough mixer with 145 kg of wheat flour,

spread 5 kg iron premix of the first step across the dough mixer

Mix for 2-5 minutes at high speed

Add kansui solution

Mix 5-10 minutes at high speed and then 5-10 minutes at low speed.

After that the normal procedure of preparing noodles is carried out, that means slitting, steaming, frying or drying.

The obtained noodles are kept during 9 months in a packaging with a flexible laminate of an indicative properties of OTR: 2000 cm3/m2.d and WVTR: 6.0 g/m2.d and by eating by the consumer, there is no off-taste and the color remain stable.

OTR=Oxygen Transmission rate

WVTR=Vapor Pressure Transmission rated

d=day

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An instant oil fried noodle comprising: between 26 and 35 mg per 100 g of noodles of iron, between 1 and 20% of oil, between 60 and 90% of flour, up to 2% of kansui ingredient and a water content between 2 and 12%.

2. An instant oil-fried noodle of claim 1 wherein the iron compound is selected from the group consisting of ferric pyrophosphate, sodium ferric EDTA, elemetal iron and ferrous ammonium phosphate.

3. An instant oil-fried noodle of claim 1 wherein the flour is selected from the group consisting of rice, barley, maize, millet and multigrain flour.

4. An instant oil-fried noodle of claim 1 wherein the fat is selected from the group consisting of palm oil, palm olein, corn oil, sunflower oil and other vegetable oils.

5. An instant oil-fried noodle of claim 1 comprising further up to 30% of native or modified starch from corn, tapioca or potato.

6. A process for the preparation of an instant oil-fried noodle comprising
preparing an iron premix with flour, iron compound; and
introducing the iron premix in a mixer with the required amount of flour and oil, mixing at high speed, adding kansui ingredient and mixing again at high speed and wherein the obtained dough is processed by kneading, rolling into sheets, slitting, steaming and drying or frying.

7. A process according to claim 6, wherein the drying is performed by air.

8. A process according to claim 6, wherein the frying is performed in oil.

9. A process for the preparation of the instant oil-fried noodle comprising
preparing a mixture of oil, wheat flour, iron compound, water
adding to this mixture a concentrate comprising sodium and potassium salt additives;
processing the dough mixture by kneading rolling into sheets, cutting into strips and steaming; and
drying the dough mixture with air.
